(19) United States
(12) Patent Application Publication
(10) Pub. No.: US 2025/0379379 A1
(43) Pub. Date: Dec. 11, 2025

(54) ELECTRICAL CONNECTOR AND ASSOCIATED WIRELESS COMMUNICATION DEVICE

(71) Applicant: Realtek Semiconductor Corp., HsinChu (TW)

(72) Inventor: Ching-Wei Ling, HsinChu (TW)

(73) Assignee: Realtek Semiconductor Corp., HsinChu (TW)

(21) Appl. No.: 19/198,145

(22) Filed: May 5, 2025

(30) Foreign Application Priority Data
Jun. 11, 2024 (TW) 113121409

(51) Int. Cl. H01R 12/71; H01R 4/02; H01R 13/6461; H01R 13/6581

(52) U.S. Cl. CPC H01R 12/71; H01R 4/02; H01R 13/6461; H01R 13/6581

(57) ABSTRACT

An electrical connector for reducing electromagnetic interference (EMI) and an associated wireless communication device are provided. The electrical connector includes multiple metal terminals, a plastic component, a wave absorbing material and a metal shell. The multiple metal terminals are configured to transmit at least one pair of differential signals from a host device to a wireless communication circuit via a printed circuit board (PCB). The plastic component is configured to fix positions of the multiple metal terminals in the electrical connector. The wave absorbing material is configured to absorb an electromagnetic wave signal sent from the multiple metal terminals. The metal shell is configured to cover the multiple metal terminals, the plastic component and the wave absorbing material. More particularly, the wave absorbing material overlaps at least a portion of the plastic component.

### BACKGROUND OF THE INVENTION

### 1. Field of the Invention

The present invention is related to wireless communication, and more particularly, to an electrical connector for reducing electromagnetic interference and an associated wireless communication device.

### 2. Description of the Prior Art

With the development of wireless communication along with a significant increase in data transmission volume, a transmission speed of the universal serial bus (USB) 2.0 standard can no longer meet the demands of users. As a result, the USB 3.0 standard has been widely adopted in various consumer electronic products, offering better transmission speed and efficiency. When a wireless receiver is plugged into a USB 3.0 port, however, an antenna on the wireless receiver will be located quite close to the USB 3.0 port, and the generated electromagnetic interference will affect both stability and speed of wireless communication. More particularly, a signal frequency of the USB 3.0 standard is significantly increased in comparison with the USB 2.0 standard, making issues of electromagnetic interferences even more severe.

Sources of the electromagnetic interferences include common mode noise and differential mode noise. The common mode noise can typically be suppressed by installing a common mode noise filter to reduce electromagnetic interference from the common mode noise; however, electromagnetic interference from the differential mode noise cannot be resolved by this method, such that quality of wireless communication is still negatively affected. Thus, there is a need for a novel architecture which can address electromagnetic interference issues caused by the USB 3.0 standard in wireless communication.

### SUMMARY OF THE INVENTION

An objective of the present invention is to provide an electrical connector for reducing electromagnetic interference and an associated wireless communication device, in order to reduce electromagnetic interference caused by differential mode signals of universal serial bus (USB) 3.0 standard without introducing any side effect or in a way that is less likely to introduce side effects.

At least one embodiment of the present invention provides an electrical connector for reducing electromagnetic interference. The electrical connector comprises multiple metal terminals, a plastic component, a wave absorbing material and a metal shell. The multiple metal terminals are configured to transmit at least one pair of differential signals from a host device to a wireless communication circuit via a printed circuit board (PCB). The plastic component is configured to fix positions of the multiple metal terminals in the electrical connector. The wave absorbing material is configured to absorb an electromagnetic wave signal generated by the at least one pair of differential signals. The metal shell is configured to cover the multiple metal terminals, the plastic component and the wave absorbing material. More particularly, the wave absorbing material overlaps at least a portion of the plastic component.

At least one embodiment of the present invention provides a wireless communication device. The wireless communication device comprises an antenna, a wireless communication circuit and an electrical connector, where the wireless communication circuit is coupled to the antenna and attached to a printed circuit board (PCB), and the electrical connector is attached to the PCB. The wireless communication circuit is configured to execute a wireless communication function, and the electrical connector is configured to connect the PCB to a host device. The electrical connector comprises multiple metal terminals, a plastic component, a wave absorbing material and a metal shell. The multiple metal terminals are configured to transmit at least one pair of differential signals from the host device to the wireless communication circuit via the PCB. The plastic component is configured to fix positions of the multiple metal terminals in the electrical connector. The wave absorbing material is configured to absorb an electromagnetic wave signal emitted by the multiple metal terminals. The metal shell is configured to cover the multiple metal terminals, the plastic component and the wave absorbing material. More particularly, the wave absorbing material overlaps at least a portion of the plastic component.

The electrical connector and the associated wireless communication device provided by the embodiments of the present invention can reduce electromagnetic interference from differential mode signals by installing wave absorbing material in an electrical connector, thereby improving signal transmission quality of the wireless communication device. In addition, the embodiments of the present invention will not greatly increase additional costs. Thus, the present invention can solve the problem of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication device according to an embodiment of the present invention.

FIG. 2 is a diagram illustrating an electrical connector according to an embodiment of the present invention.

FIG. 3 is a diagram illustrating multiple metal terminals within the electrical connector shown in FIG. 2 according to an embodiment of the present invention.

FIG. 4 is a diagram illustrating a plastic component within the electrical connector shown in FIG. 2 according to an embodiment of the present invention.

FIG. 5 is a diagram illustrating a wave absorbing material within the electrical connector shown in FIG. 2 according to an embodiment of the present invention.

FIG. 6 is a diagram illustrating a metal shell within the electrical connector shown in FIG. 2 according to an embodiment of the present invention.

FIG. 7 is a diagram illustrating an electrical connector according to another embodiment of the present invention.

FIG. 8 is a diagram illustrating an electrical connector according to yet another embodiment of the present invention.

### DETAILED DESCRIPTION

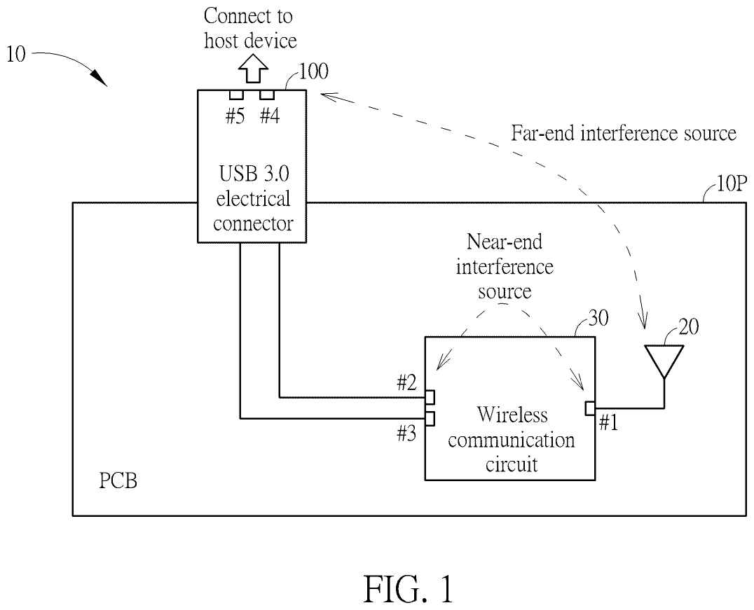

FIG. 1 is a diagram illustrating a wireless communication device 10 according to an embodiment of the present invention, where the wireless communication device 10 may be a wireless network interface card, but the invention is not limited thereto. As shown in FIG. 1, the wireless communication device 10 may comprise an antenna 20, a wireless communication circuit 30 (e.g. a wireless communication integrated circuit), and an electrical connector such as a universal serial bus (USB) 3.0 electrical connector 100, where the wireless communication circuit 30 is coupled to the antenna 20 and is attached (e.g. soldered) to a printed circuit board (PCB) 10P, and one side of the USB 3.0 electrical connector 100 is attached (e.g. soldered) to the PCB 10P. In this embodiment, the wireless communication circuit 30 is configured to execute a wireless communication function, and the USB 3.0 electrical connector 100 is configured to connect the PCB 10P to a host device. In particular, the USB 3.0 electrical connector 100 may be a USB 3.0 plug, which allows the wireless communication device 10 to be inserted into a socket of the host device (not shown), wherein when the wireless communication device 10 is inserted into the host device via the USB 3.0 electrical connector 100, the host device may communicate with the wireless communication circuit 30 to control the wireless communication function through the wireless communication circuit 30.

In this embodiment, the wireless communication circuit 30 is coupled to the antenna 20 via a port #1 thereof, and is coupled to the USB 3.0 electrical connector 100 via ports #2 and #3 thereof and metal traces on the PCB 10P. The USB 3.0 electrical connector 100 receives a pair of differential signals from the host device via ports #4 and #5 thereof, in order to transmit the pair of differential signals to ports #2 and #3 of the wireless communication circuit 30 via the metal traces on the PCB 10P. Based on the above operations, electromagnetic interference sources encountered by signals transmitted from the antenna 20 may comprise electromagnetic interference from the pair of differential signals on the ports #4 and #5 of the USB 3.0 electrical connector 100, which are coupled to the antenna 20 via air (which may be regarded as a far-end interference source), as well as electromagnetic interference from the pair of differential signals on the PCB 10P, which are coupled to the antenna 20 via the ports #2, #3, and #1 of the wireless communication circuit 30 (which can be regarded as a near-end interference source). More particularly, the pair of differential signals is transmitted from the host device to the wireless communication device 10 via the USB 3.0 electrical connector 100, and therefore the ports #4 and #5 of the USB 3.0 electrical connector 100 are positions where the pair of differential signals has the highest signal strength on the wireless communication device 10. The present invention places a wave absorbing material in the USB 3.0 electrical connector 100 to reduce signal strength of electromagnetic wave signals radiating from the ports #4 and #5 of the USB 3.0 electrical connector 100 as much as possible, thereby preventing quality of the signals transmitted by the antenna 20 from being affected by the radiated electromagnetic wave signals.

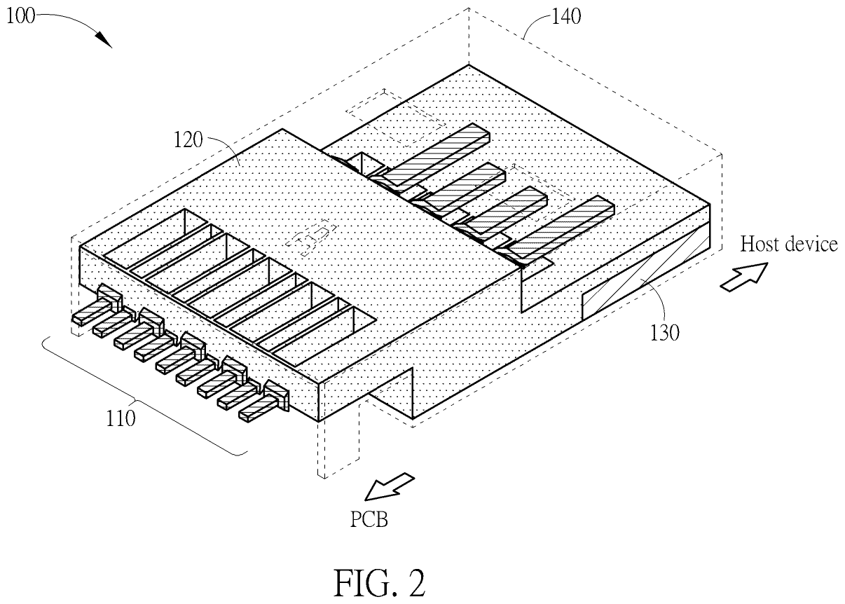

FIG. 2 is a diagram illustrating an electrical connector (such as the USB 3.0 electrical connector 100 shown in FIG. 1) according to an embodiment of the present invention, where an upper-right side of the USB 3.0 electrical connector 100 in FIG. 2 is placed to face a direction of insertion into a socket of the host device, and a lower-left side of the USB 3.0 electrical connector 100 is attached to the PCB 10P. In this embodiment, the USB 3.0 electrical connector 100 may comprise multiple metal terminals 110, a plastic component 120, a wave absorbing material 130 (e.g. electromagnetic wave absorbing material) and a metal shell 140, where the multiple metal terminals 110, the plastic component 120, the wave absorbing material 130, and the metal shell 140 are shown with different patterns (textures) in FIG. 2 for better identification. In this embodiment, the multiple metal terminals 110 are configured to transmit the pair of differential signals from the host device to the wireless communication circuit 30 via the PCB 10P. The plastic component 120 is configured to fix positions of the multiple metal terminals 110 in the USB 3.0 electrical connector 100; more particularly, having a structure corresponding to the socket of the host device to ensure that the multiple metal terminals 110 make contact with metal terminals within the socket of the host device when inserted into the socket of the host device. The wave absorbing material 130 is configured to absorb an electromagnetic wave signal emitted by the multiple metal terminals 110 (more particularly, the pair of differential signals transmitted thereon). The metal shell 140 is configured to cover the multiple metal terminals 110, the plastic component 120 and the wave absorbing material 130. The wave absorbing material 130 overlaps at least a portion of the plastic component 120. For better comprehension of the whole structure, the metal shell 140 is shown in a perspective view.

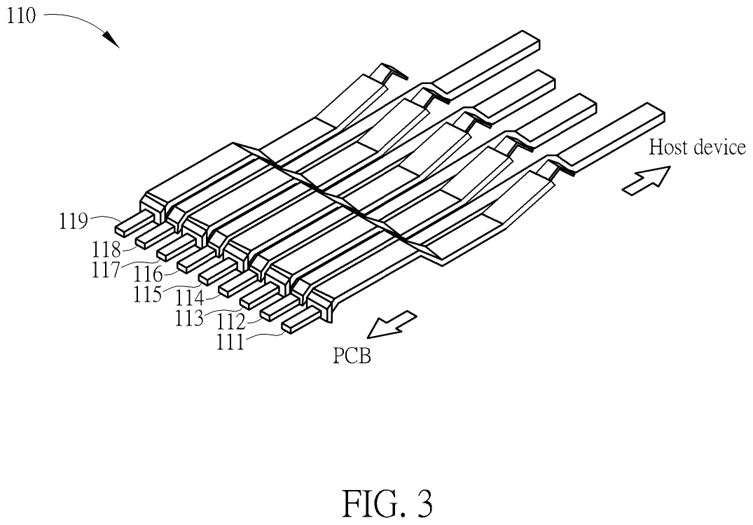

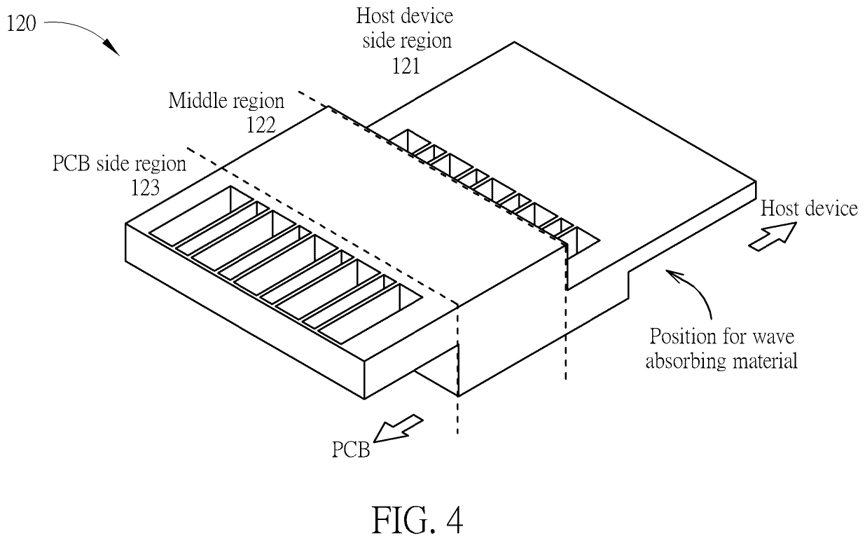

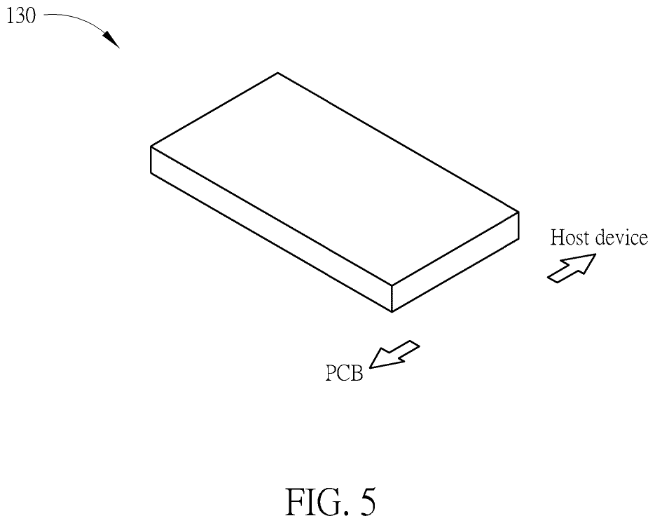

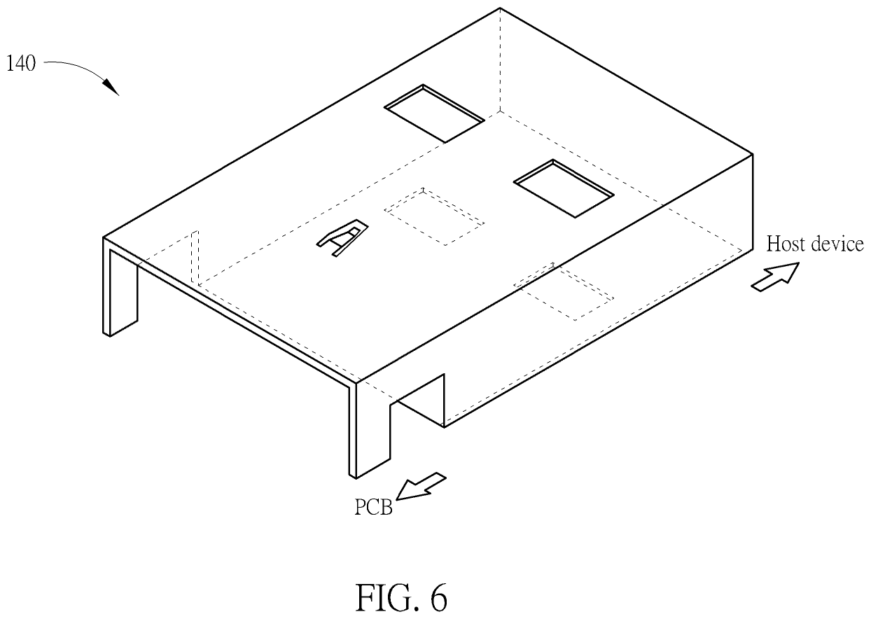

To further understand the structure of the USB 3.0 electrical connector 100 shown in FIG. 2, disassembled versions of the USB 3.0 electrical connector 100 are shown in FIG. 3 to FIG. 6. FIG. 3 is a diagram illustrating the multiple metal terminals 110 within the USB 3.0 electrical connector 100 shown in FIG. 2 according to an embodiment of the present invention. FIG. 4 is a diagram illustrating the plastic component 120 within the USB 3.0 electrical connector 100 shown in FIG. 2 according to an embodiment of the present invention. FIG. 5 is a diagram illustrating the wave absorbing material 130 within the USB 3.0 electrical connector 100 shown in FIG. 2 according to an embodiment of the present invention shown in FIG. 2. FIG. 6 is a diagram illustrating the metal shell 140 within the USB 3.0 electrical connector 100 shown in FIG. 2 according to an embodiment of the present invention shown in FIG. 2.

In the embodiment of FIG. 3, the multiple metal terminals 110 may comprise metal terminals 111, 112, 113, 114, 115, 116, 117, 118 and 119 (which are referred to as the metal terminals 111-119), where two of the metal terminals 111-119 (e.g. the metal terminals 112 and 113) may be connected to the ports #4 and #5 of the wireless communication device 10, respectively, and are configured to transmit the pair of differential signals.

In the embodiment of FIG. 4, the plastic component 120 may comprise a host device side region 121, a middle region 122 and a PCB side region 123, where the host device side region 121 is a portion of the plastic component 120 that is inserted into the socket of the host device, the PCB side region 123 is a portion of the plastic component 120 that is attached to the PCB 10P (more particularly, a portion where the multiple metal terminals 110 overlap the PCB side region 123 may be soldered to the PCB 10P), and the middle region 122 is a portion of the plastic component 120 that connects the host device side region 121 and the PCB side region 123. In this embodiment, at least a portion of the plastic component 120 may be configured with a space corresponding to a shape of the wave absorbing material 130 shown in FIG. 5, to serve as a position for the wave absorbing material 130.

As mentioned above, the wireless communication circuit 30 may be coupled to the antenna 20, and the wave absorbing material 130 is configured to reduce energy of the electromagnetic wave signal emitted by the multiple metal terminals 110 (more particularly, the pair of differential signals transmitted thereon) to prevent signals transmitted by the antenna 20 from being interfered with. In particular, the wave absorbing material 130 can absorb electromagnetic wave energy on surfaces of the multiple metal terminals 110 and convert it into heat energy, thereby avoiding electromagnetic interference or electromagnetic leakage caused by secondary reflections.

In addition, as a position of the USB 3.0 electrical connector 100 that is closest to the host device has the highest electromagnetic wave energy, the wave absorbing material 130 is preferably configured to overlap at least a portion of the host device side region 121, and more particularly, may be aligned with a boundary of the host device side region 121 that is closest to the host device, in order to achieve optimal electromagnetic wave absorption. Compared to not using any wave absorbing material, configuration of the wave absorbing material 130 in FIG. 2 (e.g. placing the wave absorbing material 130 beneath a portion of the host device side region 121) can effectively reduce power of differential mode noise (e.g. noise in the pair of differential signals). Although the embodiment in FIG. 2 places the wave absorbing material 130 beneath a portion of the host device side region 121 only, and the rest of the region is without any wave absorbing material, the invention is not limited thereto. For example, the wave absorbing material 130 may be extended to overlap the entirety of the host device side region 121.

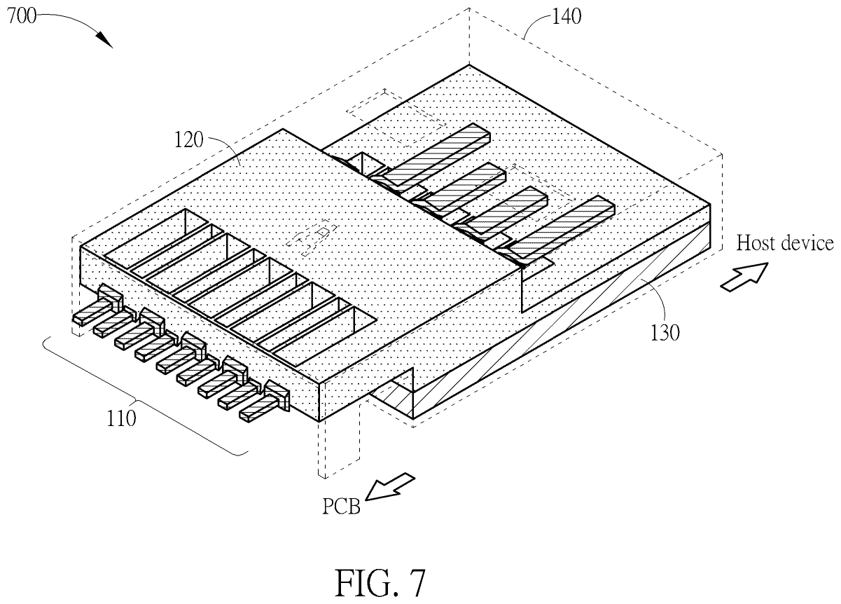

FIG. 7 is a diagram illustrating an electrical connector, such as a USB 3.0 electrical connector 700, according to another embodiment of the present invention. In comparison with the electrical connector 100 shown in FIG. 2, the difference is that the wave absorbing material 130 used in the USB 3.0 electrical connector 700 shown in FIG. 7 may be further extended to the middle region 122 of the plastic component 120, where the wave absorbing material 130 overlaps both the host device side region 121 and the middle region 122 (e.g. placing the wave absorbing material 130 beneath the entirety of the host device side region 121 and the middle region 122).

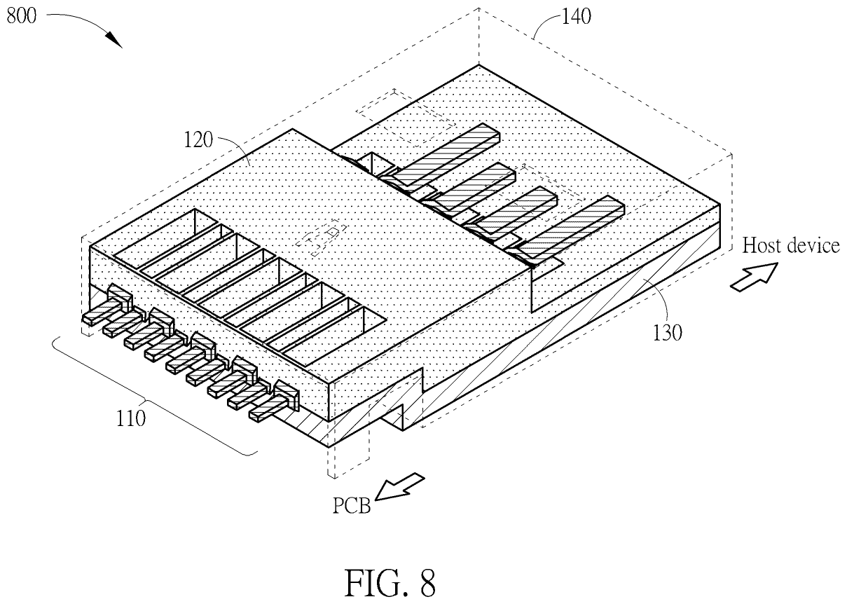

FIG. 8 is a diagram illustrating an electrical connector, such as a USB 3.0 electrical connector 800, according to yet another embodiment of the present invention. In comparison with the electrical connector 100 shown in FIG. 2, the difference is that the wave absorbing material 130 used in the USB 3.0 electrical connector 800 shown in FIG. 8 may be further extended to the PCB side region 123 of the plastic component 120, where the wave absorbing material 130 overlaps the entirety of the plastic component 120 (e.g. placing the wave absorbing material 130 beneath the entirety of the host device side region 121, the middle region 122 and the PCB side region 123).

It should be noted that the position of the wave absorbing material 130 mentioned above is a preferred example which considers both manufacturing costs and electromagnetic wave isolation, but is not meant to be a limitation of the present invention. As long as the wave absorbing material 130 is placed in the electronic connector (e.g. the USB 3.0 electrical connector 100, 700 or 800) to absorb the electromagnetic wave signal caused by the pair of differential signals (e.g. the differential mode noise mentioned above), the exact position, size, and shape of the wave absorbing material can vary.

To summarize, the electrical connector provided by the embodiments of the present invention can place the wave absorbing material in the region having the highest electromagnetic wave energy in the electrical connector, to thereby greatly reduce impact of both far-end interference and near-end interference sources. Furthermore, the embodiments of the present invention will not greatly increase additional costs. Thus, the present invention can solve the problem of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrical connector for reducing electromagnetic interference, comprising:
multiple metal terminals, configured to transmit at least one pair of differential signals from a host device to a wireless communication circuit via a printed circuit board (PCB);
a plastic component, configured to fix positions of the multiple metal terminals in the electrical connector;
a wave absorbing material, configured to absorb an electromagnetic wave signal generated by the at least one pair of differential signals; and
a metal shell, configured to cover the multiple metal terminals, the plastic component and the wave absorbing material;
wherein the wave absorbing material overlaps at least a portion of the plastic component.

2. The electrical connector of claim 1, wherein the wireless communication circuit is coupled to an antenna, and the wave absorbing material is configured to reduce energy of the electromagnetic wave signal to prevent signals transmitted by the antenna from being interfered with.

3. The electrical connector of claim 1, wherein the plastic component comprises a host device side region, a middle region, and a PCB side region, the host device side region is a portion of the plastic component that is inserted into a socket of the host device, the PCB side region is a portion of the plastic component that is attached to the PCB, and the middle region is a portion of the plastic component that connects the host device side region and the PCB side region.

4. The electrical connector of claim 3, wherein the wave absorbing material overlaps at least a portion of the host device side region.

5. The electrical connector of claim 3, wherein the wave absorbing material overlaps the host device side region and the middle region.

6. The electrical connector of claim 3, wherein the wave absorbing material overlaps the entirety of the plastic component.

7. A wireless communication device, comprising:
an antenna;
a wireless communication circuit, coupled to the antenna and attached to a printed circuit board (PCB), configured to execute a wireless communication function;
an electrical connector, attached to the PCB, configured to connect the PCB to a host device, wherein the electrical connector comprises:
multiple metal terminals, configured to transmit at least one pair of differential signals from the host device to the wireless communication circuit via the PCB;
a plastic component, configured to fix positions of the multiple metal terminals in the electrical connector;
a wave absorbing material, configured to absorb an electromagnetic wave signal emitted by the multiple metal terminals; and
a metal shell, configured to cover the multiple metal terminals, the plastic component and the wave absorbing material;
wherein the wave absorbing material overlaps at least a portion of the plastic component.

8. The wireless communication device of claim 7, wherein the wave absorbing material is configured to reduce energy of the electromagnetic wave signal to prevent signals transmitted by the antenna from being interfered with.

9. The wireless communication device of claim 7, wherein the plastic component comprises a host device side region, a middle region, and a PCB side region, the host device side region is a portion of the plastic component that is inserted into a socket of the host device, the PCB side region is a portion of the plastic component that is attached to the PCB, and the middle region is a portion of the plastic component that connects the host device side region and the PCB side region.

10. The wireless communication device of claim 9, wherein the wave absorbing material overlaps at least a portion of the host device side region.

11. The wireless communication device of claim 9, wherein the wave absorbing material overlaps the host device side region and the middle region.

12. The wireless communication device of claim 9, wherein the wave absorbing material overlaps the entirety of the plastic component.
